(19) United States
(12) Patent Application Publication
(10) Pub. No.: US 2009/0194563 A1
(43) Pub. Date: Aug. 6, 2009

(54) Foot Operated Foaming Soap Dispenser

(75) Inventors: Peter C. Lewis, Holliston, MA (US); Alexandra B. Lewis, Holliston, MA (US)

Correspondence Address: CANTOR COLBURN, LLP, 20 Church Street, 22nd Floor, Hartford, CT, 06103, US

(73) Assignee: Highland Labs Inc., Holliston, MA (US)

(21) Appl. No.: 12/362,839

(22) Filed: Jan. 30, 2009

Related U.S. Application Data
(60) Provisional application No. 61/063,042, filed on Jan. 31, 2008.

(51) Int. Cl. B67D 5/58; B67D 5/06

(52) U.S. Cl. 222/1; 222/190; 222/179

(57) ABSTRACT

A dispensing apparatus includes an outer housing having a receiving section for coupling with a liquid container and a pumper. The pumper includes a pumper inlet and pumper outlet and is designed and configured to receive a liquid from a liquid container at the pumper inlet, convert the liquid into a foam, and to expel foam through the pumper outlet. The apparatus also includes a piston having a piston inlet and a piston outlet, the piston inlet capable of fluid communication with the pumper outlet and a pumping mechanism.

### PRIORITY CLAIM

This application claims priority under 35 U.S.C. §119 to U.S. Provisional Patent Application Ser. No. 61/063,042 filed Jan. 31, 2008, and entitled Foot Operated Foaming Soap Dispenser.

### BACKGROUND

This invention relates generally to soap dispensers and more particularly to foot operated soap dispensers that produce foamed soap.

In many settings, and in hospitals in particular, it is important to ensure that persons employed in such settings maintain their hands in a clean state. As is well known, the use of soap is an effective means for cleaning one's hands.

Typically soap is dispensed either in a bar or liquid form. Liquid dispenser for dispensing soap and the like are well known, and there are a wide variety of liquid dispensers. In many instances, liquid soap is provided in a container that has a hand activated spout that, when pressed down, emits the soap in the liquid form.

One common type of dispenser for liquid soap includes a cap with a nozzle portion that pivots from an in use position to a stowed position. In the in use position the nozzle is in flow communication with the interior of the dispenser. In the stowed position the distal end of the nozzle is inside the cap and thus liquid cannot escape. The advantage of this common dispenser cap is that it uses relatively few parts and is easy to use. The disadvantage is that when the dispenser is in the nozzle down position and the nozzle is in the in use position liquid will likely seep out continuously.

Another dispenser for liquid soap is shown in U.S. Pat. No. 4,324,349 issued to Kaufman on Apr. 13, 1982. This dispenser includes a squeeze bottle with an air pocket structure disposed at the lower end of the bottle. The air pocket structure is in flow communication with the inside of the bottle and has an outlet so that liquid can flow from the bottle into the air pocket and out of the outlet.

Alternatively foam dispensers are used to dispense soap in the form of foam. The advantage of these dispensers is there tends to be much less waste due to splashing or run-off since the foam has much higher surface tension than the corresponding liquid. Foam dispensers typically fall into two general types. One type produces foam by injecting a jet of air. The second type uses porous material or mesh and a combination of liquid and air mixed together and then forced through the mesh to form a foam.

One example of a foam dispenser is show in U.S. Pat. No. 5,984,146 issued Nov. 16, 1999 to Kaufman. This foam dispenser includes a reservoir for containing a pool of liquid up to a predetermined level. The foam dispenser includes a discharge chamber which contains air above the level of the liquid and a discharge device includes a which extends upwardly from the reservoir at least partly through the discharge chamber. The discharge device has an external outlet. The discharge device includes a foam chamber and pressure means, whereby pressure applied to the liquid in the reservoir drives liquid into the discharge device. This foam dispenser includes a separate discharge or air chamber, which causes the device to be quite bulky. This foam dispenser has a number of components which make it more costly to manufacture than a device with fewer components. Further, the foam chamber of this foam dispenser has a plurality of very small pinprick sized holes in a tubular portion which would be difficult and expensive to produce. In addition, to modify this foam dispenser to produce different foam characteristics or to use a different consistency of foaming soap would require modifying the foam chamber and would be difficult and expensive to do.

One problem with dispensers using prior art foamers is that the nozzle portion is touched by the user's hands before the user's hands are clean. Thus, the germs present on the user's hands may be transferred to the soap-dispensing device. These germs may then be spread by other persons touching the device or, alternatively, in an airborne fashion.

Another draw back of current soap-dispensing devices is that the soap is dispensed in a liquid format. When the liquid touches a person's hands and water is subsequently applied much of the soap is washed instantly off the person's hands. This results is a substantial amount of wasted liquid soap. Thus, current methods of dispensing soap suffer from at least two disadvantages: (1) the soap-dispensing apparatus is a location where germs may collect; and (2) the amount of soap wasted directly effects the cost of cleanliness.

### SUMMARY OF THE INVENTION

The present invention is directed to a foot-operated, foaming soap dispenser which may solve one ore more of the above-listed problems. Specifically, embodiments of the present invention are directed to systems and methods for dispensing soap. One embodiment is directed to a soap dispenser that is foot operated and therefore is not touched by a human's hands. In addition, some embodiments of the present invention may also include a “pumping device” that converts liquid soap into a foam. In this manner the amount of soap generally used may be significantly reduced and lead to cost savings.

One embodiment of the present invention includes an outer housing having a receiving section for coupling with a liquid container. This embodiment also includes a pumper having a pumper inlet and a pumper outlet and designed and configured to receive a liquid from a liquid container at the pumper inlet, convert the liquid into a foam, and to expel foam through the pumper outlet. The embodiment also includes a piston having a piston inlet and a piston outlet. This embodiment may also include a pumping mechanism having an internal portion and an external portion, wherein the internal portion is located at least partially within the outer housing and the external portion is coupled to the internal portion, and the internal portion is coupled to the piston in such a manner that when a force is applied to the external portion the internal portion drives the piston towards the pumper.

Another embodiment of the present invention is directed to a method of dispensing a soap in a foamed state. The method of this embodiment may include: receiving air from foot pump at an air inlet; communication the air received from the foot pump to a chamber having a deflectable diaphragm which defines a portion of the outer periphery of the chamber; positioning at least a portion of the diaphragm in contact with a piston such that the piston is driven towards the bottle containing a liquid soap; interposing a pumper that converts a liquid soap into a foam between the piston and the bottle; and communicating the foam from the pumper to an outlet port.

The present invention and its advantages over the prior art will be more readily understood upon reading the following detailed description and the appended claims with reference to the accompanying drawings.

### BRIEF DESCRIPTION OF THE DRAWINGS

The subject matter which is regarded as the invention is particularly pointed out and distinctly claimed in the claims at the conclusion of the specification. The invention, however, may be best understood by reference to the following description take in conjunction with the accompanying drawing figures in which:

FIG. 1 shows a cut-away view of one embodiment of a soap dispenser in accordance with the present invention;

FIG. 2 shows a bottom view of one embodiment of a soap dispenser showing a threaded receiving region;

FIG. 3 is a more detailed cutaway version of the pumping apparatus;

FIG. 4 is an alternative view of the soap dispenser shown in FIG. 1; and

FIG. 5 shows a cutaway side view of a piston.

### DETAILED DESCRIPTION OF THE INVENTION

Referring to the drawings wherein identical reference numerals denote the same elements throughout the various views.

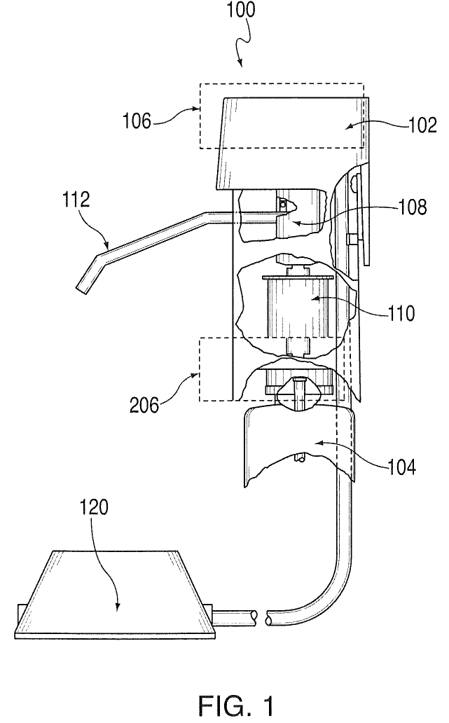

The present invention is related to a foot operated foaming soap dispenser. FIG. 1 shows a cutaway view of one embodiment of a soap dispenser 100 in accordance with the present invention. The soap dispenser 100 includes housing 102 (shown in cutaway) which is designed to mate with and support a standard soap containing bottle 104 having an upper threaded portion.

Referring again to FIG. 1, dispenser 100 may alternatively include receiving section 206 implemented as a latch and a retainer shaped and arranged for reciprocating movement on the guide between open and closed positions and in a first direction relative to the housing and for reciprocating movement in a second direction for different than the first direction between the closed position and a latched position. The retainer, in its closed position, prevents removal, and in its latched position, is prevented from movement in the first direction by latch. The retainer discourages unauthorized removal of the container from the dispenser 100. An example of such receiving section implemented as just described is more fully explained in U.S. Pat. No. 6,041,974 which is incorporated herein by reference in its entirety.

Referring again to FIG. 1, dispenser 100 may also include a pump drive portion 106 and a piston 108. In operation, the pump drive portion 106 causes piston 108 to be forced in a downward direction towards the bottle 104. In certain embodiments the piston 108 is driven down towards a pumper 110 which causes a soap to be expelled from the bottle through the pumper and through an output terminal 112 of the piston 108. In some embodiments, the pumper 110 may cause the soap to be converted from a liquid into a foam. Examples of such pumpers are well known in the prior art and, for example, are described in greater detail U.S. Pat. No. 6,053,364, which is hereby incorporated by reference in its entirety.

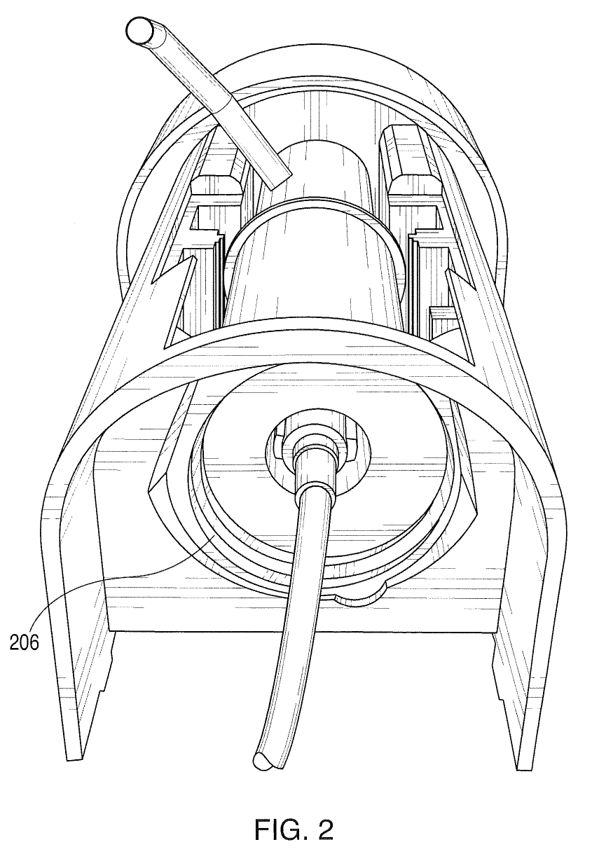

FIG. 2 shows a bottom view of a dispenser according to the present invention. This embodiment includes a mating portion 206 configured to mate with a bottle of liquid soap and solidly attach the two together.

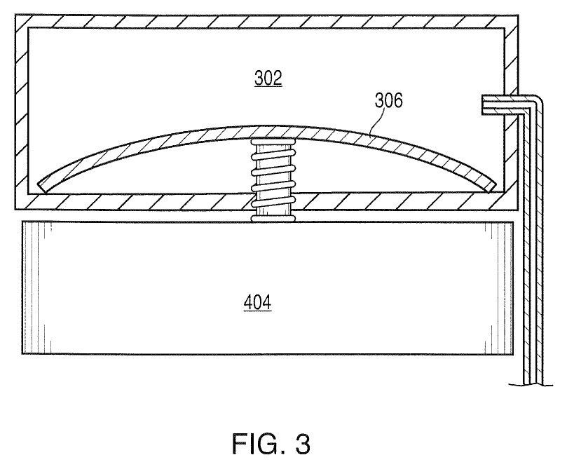

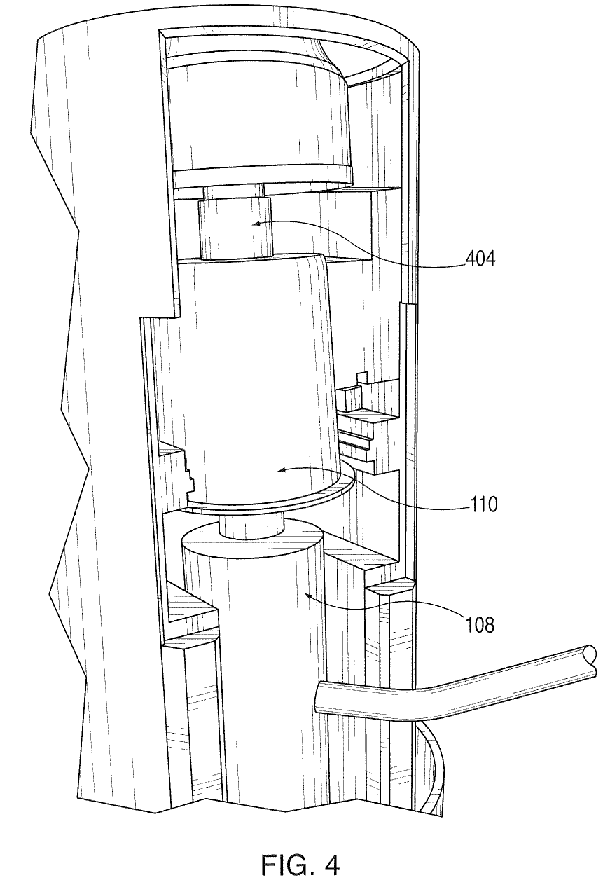

FIG. 3 is a more detailed cutaway side view of the pump drive portion 106. The pump drive portion 106 receives an air receiving chamber 302 which receives air from an external source. This external source may, for example, be either a hand pump or a foot pump (see e.g. foot pump 120 in FIG. 1). The air receiving portion 302 may include a diaphragm 306 that as air is forced into the air receiving section 302, causes the diaphragm 306 to force a drive portion 404 (see also FIG. 4) of the pumping mechanism to force the piston 108 in a downward direction. As discussed previously, pushing the piston 108 in a downward direction causes the pumper 110 to push air soap through the piston and out through the output terminal 112. As shown, the output terminal is a tube but any other type of exit orifice may suffice and could be used as a replacement for the tube shown in FIGS. 1-4.

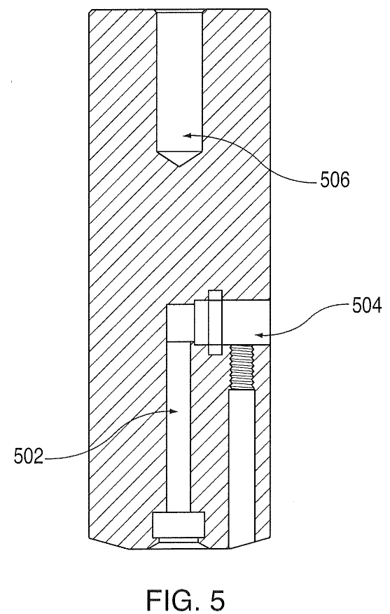

FIG. 5 shows a cutaway side view of a piston 108. The piston 108 includes a through channel 502 that allows for the liquidified soap to pass from the pumper through the output orifice 504. The through-channel 502 allows for the prison to be in fluid communication with the pumper. The piston 108 may also include a receiving hole 502 to receive a projection from the pumping mechanism. Of course such a receiving hole could be omitted.

In operation, as pressure is applied to the top of the piston 108 which is translated downward causing a pumper 110 to bring liquid soap into itself and emit the soap as a foam at the entrance through-channel 502. This foam is expelled through the output orifice 504 and onto the user's hands. As one in the ordinary skill would readily realize by employing a foot pump, the user may never have to touch the soap dispenser 100 with their hands while still being able to receive a foam soap from the dispenser 100. As discussed above, this provides numerous advantages.

While specific embodiments of the present invention have been described, it should be noted that various modification thereto can be made without departing from the spirit and scope of the invention as defined in the appended claims.

What is claimed is:

1. A dispensing apparatus comprising:
an outer housing having a receiving section for coupling with a liquid container;
a pumper having a pumper inlet and pumper outlet and designed and configured to receive a liquid from a liquid container at the pumper inlet, convert the liquid into a foam, and to expel foam through the pumper outlet;
a piston having a piston inlet and a piston outlet, the piston inlet capable of fluid communication with the pumper outlet; and
a pumping mechanism having an internal portion and an external portion, wherein the internal portion is located at least partially within the outer housing and the external portion is coupled to the internal portion, and wherein the internal portion is coupled to the piston in such a manner that when a force is applied to the external portion the internal portion drives the piston towards the pumper.

2. The apparatus of claim 1, wherein the receiving section of the outer housing is a threaded receptacle.

3. The apparatus of claim 1, wherein the liquid in the liquid container is soap.

4. The apparatus of claim 1, wherein the piston includes an outlet nozzle.

5. The apparatus of claim 1, wherein the piston includes a receptacle for coupling to the pumping mechanism.

6. The apparatus of claim 1, wherein the external portion of the pumping mechanism is a foot pump coupled to the internal portion by an air tube.

7. The apparatus of claim 1, wherein the external portion of the pumping mechanism is a wall mounted pump coupled to the internal portion by an air tube.

8. The apparatus of claim 1, wherein the internal portion of the pumping mechanism includes a pumping inlet for receiving air from the external portion.

9. The apparatus of claim 8, wherein the pumping mechanism further includes a diaphragm chamber having an upper portion in fluid communication with the pumping inlet and a lower portion.

10. The apparatus of claim 9, wherein the lower portion contacts the piston.

11. A method of dispensing a soap in a foamed state comprising:
receiving air from a foot pump at an air inlet;
communicating the air received from the foot pump to a chamber having a deflectable diaphragm which defines a portion of the outer periphery of the chamber;
positioning at least a portion of the diaphragm in contact with a piston such that the piston is driven towards a bottle containing a liquid soap;
interposing a pumper that converts a liquid soap into a foam between the piston and the bottle; and
communicating the foam from the pumper to an outlet port.
